(19) United States
(12) Patent Application Publication
(10) Pub. No.: US 2019/0246300 A1
(43) Pub. Date: Aug. 8, 2019

(54) COMMUNICATION LINK CHECKING METHOD

(71) Applicant: MEDIATEK INC., Hsin-chu (TW)

(72) Inventor: Li-Chun Ko, Hsin-Chu (TW)

(21) Appl. No.: 16/261,451

(22) Filed: Jan. 29, 2019

Related U.S. Application Data
(60) Provisional application No. 62/626,189, filed on Feb. 5, 2018.
(60) Provisional application No. 62/633,701, filed on Feb. 22, 2018.

(51) Int. Cl. H04W 24/08; H04B 17/318

(52) U.S. Cl. CPC H04W 24/08; H04B 17/318

(57) ABSTRACT

A communication link checking method, applied to check a communication link of a first electronic device, which comprises: (a) receiving a report message, wherein the report message comprises received strength information indicating a received signal strength of a request message received by a second electronic device and comprises wanted strength information provided by the second electronic device; and (b) determining a quality of the communication link according to the received strength information and the wanted strength information.

### CROSS REFERENCE TO RELATED APPLICATIONS

This application claims the priority of U.S. Provisional Application No. 62/626,189, filed 2018 Feb. 5, and U.S. Provisional Application No. 62/633,701, filed 2018 Feb. 22 which are included herein by reference.

### BACKGROUND

AODV (Adhoc On-Demand Distance Vector Routing) is a common technique to setup a routing path in a meth network with route requests and route replies, such as a Bluetooth network.

FIG. 1 is a schematic diagram illustrating a conventional Bluetooth network. As illustrated in FIG. 1, the mesh network 100 comprises a plurality of routers R_1-R_6. If a routing path between the router R_1 and the router R_6 is needed to be found, the router R_1 broadcasts route requests RREQ to each of other routers R_2-R_6. After that, a routing path between the router R_1 and the router R_6 is determined based on the transmitting conditions of the route requests RREQ and is reported to the router R_1 via the route replies RREP. For example, if a routing path router R_6→router R_3→router R_1 is selected based on the transmitting conditions of the route requests RREQ, the router R_6 transmits a route reply PREP to inform such routing path to the router R_1.

However, such mechanism may have some disadvantages. For example, the routing paths are established in a unidirectional manner such that an asymmetric link may exist between routers due to some factors such as different path loss or different transmitting powers of the routing paths.

### SUMMARY

Therefore, one objective of the present application is to provide a communication link checking method which can solve the asymmetric link issue.

Another one objective of the present application is to provide an electronic device applying a communication link checking method which can solve the asymmetric link issue.

One embodiment of the present application provides a communication link checking method, applied to check a communication link of a first electronic device, which comprises: (a) receiving a report message, wherein the report message comprises received strength information indicating a received signal strength of a request message received by a second electronic device and comprises wanted strength information provided by the second electronic device; and (b) determining a quality of the communication link according to the received strength information and the wanted strength information.

Another embodiment of the present application provides a communication link checking method, applied to check a communication link of a second electronic device, comprising: (a) generating and transmitting a report message to a first electronic device by the second electronic device, wherein the report message comprises received strength information indicating a received signal strength of a request message received by the second electronic device and comprises wanted strength information provided by the second electronic device provided by the second electronic device; and (b) determining a quality of the communication link according to the received strength information and the wanted strength information.

Still another embodiment of the present application provides a communication link checking method, applied to check a communication link of a first electronic device, which comprises: transmitting a plurality of test data units to a second electronic device by the first electronic device; receiving a receiving result of the test data units; and determining a quality of the communication link according to the receiving result.

Still another embodiment of the present application provides a communication link checking method, applied to check a communication link of a second electronic device, comprising: receiving a plurality of test data units from a first electronic device by the second electronic device; generating a receiving result of the test data units; and determining a quality of the communication link according to the receiving result.

The above-mentioned embodiments can be performed by a control circuit of an electronic device, which executes program codes stored in a storage device.

In view of above-mentioned embodiments, the quality of communication link can be checked, and proper communication links between routers can be selected according to the checking result. Accordingly, the conventional asymmetric link issue can be resolved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a conventional mesh network.

FIG. 2 is a block diagram illustrating a communication link checking method according to one embodiment of the present application.

FIG. 3 is a schematic diagram illustrating data structures of the request message and the report message in the embodiment of FIG. 2.

FIG. 4 and FIG. 5 are schematic diagram illustrating communication link checking methods according to different embodiments of the present application.

FIG. 6 is a schematic diagram illustrating examples for data structures of the test request message, the test data unit, the result request message, the receiving result in the embodiments of FIG. 4 and FIG. 5.

FIG. 7 is a block diagram illustrating the structures of the first electronic device or the second electronic device in FIG. 2 of the present application, according to one embodiment of the present application.

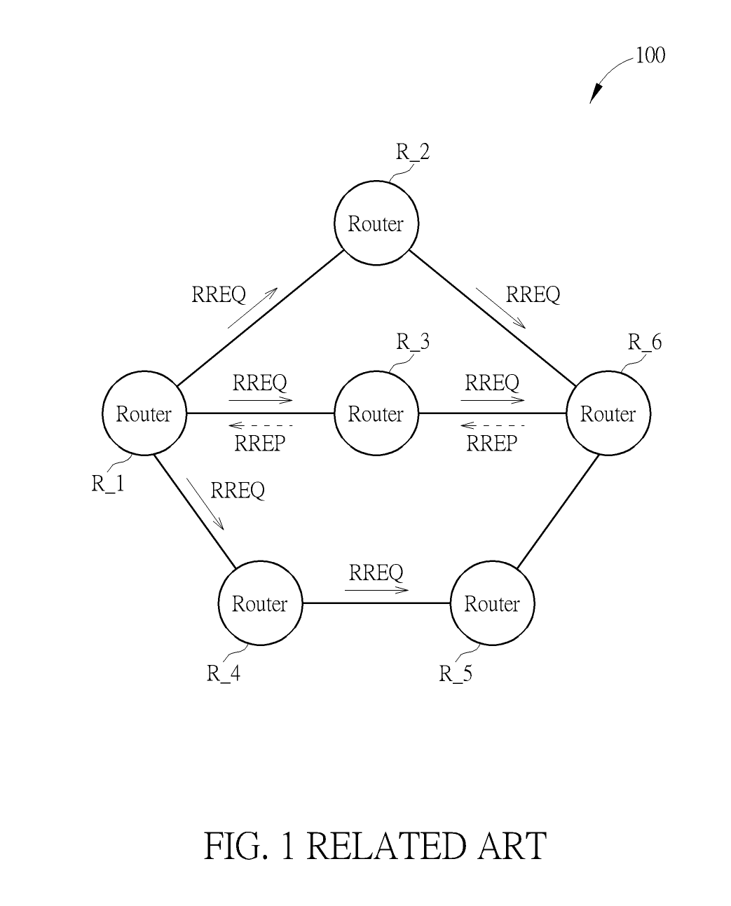

### DETAILED DESCRIPTION

In following embodiments, each component can be implemented by hardware (e.g. an apparatus or a circuit) or hardware with software (e.g. a processor installed with at least one program). Also, the methods in following embodiments can be implemented by executing program code stored in a storage device. Besides, the terms “first” “second” . . . in following embodiments are only used to identify the two different components or different steps, but do not mean to limit the order thereof.

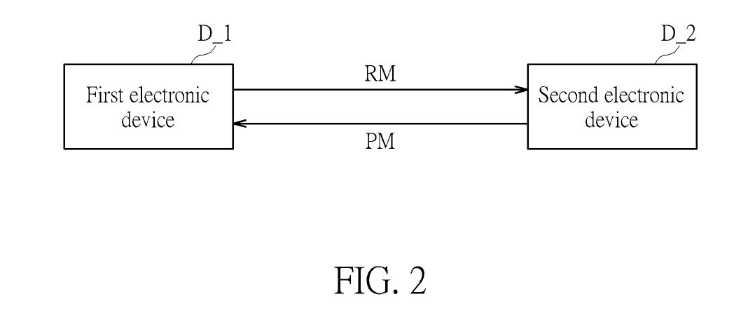

FIG. 2 is a schematic diagram illustrating a communication link checking method according to one embodiment of the present application. As illustrated in FIG. 2, a communication link checking method can be applied to cheek a communication link between a first electronic device D_1 and a second electronic device D_2. The first electronic device D_1 and the second electronic device D_2 can be Bluetooth devices or any other applicable electronic devices. The communication link checking method firstly transmits a request message RM to the second electronic device D_2 by the first electronic device D_1. The request message RM comprises transmitting power information indicating a transmitting power which the first electronic device D_1 uses to transmit the request message RM. For example, the request message RM comprises transmitting power information indicating the first electronic device D_1 uses 10 dbm to transmit the request message RM.

After receiving the request message RM, the second electronic device D_2 responds a report message PM to the first electronic device D_1. The report message PM comprises received strength information indicating a received signal strength of the request message RM and comprises wanted strength information provided by the second electronic device D_2. For example, the received signal strength of the report message RM received by the second electronic device D_2 is −80 dbm and the wanted strength information provided by the second electronic deviceD_2 indicates the second electronic deviceD_2 needs a received signal strength for at least −90 dbm. Please note, the report message PM can be further provided by another electronic device that can communicate with the second electronic device besides the second electronic device D_2.

Next, a quality of the communication link between the first electronic device D_1 and the second electronic device D_2 is determined according to at least one of: the transmitting power information, the received strength information and the wanted strength information. For example, if a difference between the transmitting power and the received signal strength is large, it means the path loss is high thus the communication link between the first electronic device D_1 and the second electronic device D_2 has a poor quality. Oppositely, if a difference between the transmitting power and the received signal strength is small, it means the path loss is low thus the communication link between the first electronic device D_1 and the second electronic device D_2 has a good quality. For another example, if a difference between the received signal strength and the wanted signal strength is large, it means the communication link is not ideal thus the communication link between the first electronic device D_1 and the second electronic device D_2 has a poor quality. Oppositely, if a difference between the received signal strength and the wanted signal strength is small, it means the communication link is more ideal thus the communication link between the first electronic device D_1 and the second electronic device D_2 has a good quality.

The above-mentioned steps can be performed by either the first electronic device D_1 or the second electronic device D_2. Also, the above-mentioned steps can be performed by an electronic device independent from the first electronic device D_1 and the second electronic device D_2. Moreover, in one embodiment, the second electronic device D_2 can initiatively transmit the report message PM to the second electronic device D_2 rather than responding to the request message RM.

In one embodiment, the first electronic device D_1 and the second electronic device D_2 are routers of a network. The network can be, for example, the above-mentioned mesh network, but can be any other kind of network as well. Furthermore, the first electronic device D_1 and the second electronic device D_2 can be provided in the same area (e.g. city, province, or country), but can be provided in different areas as well.

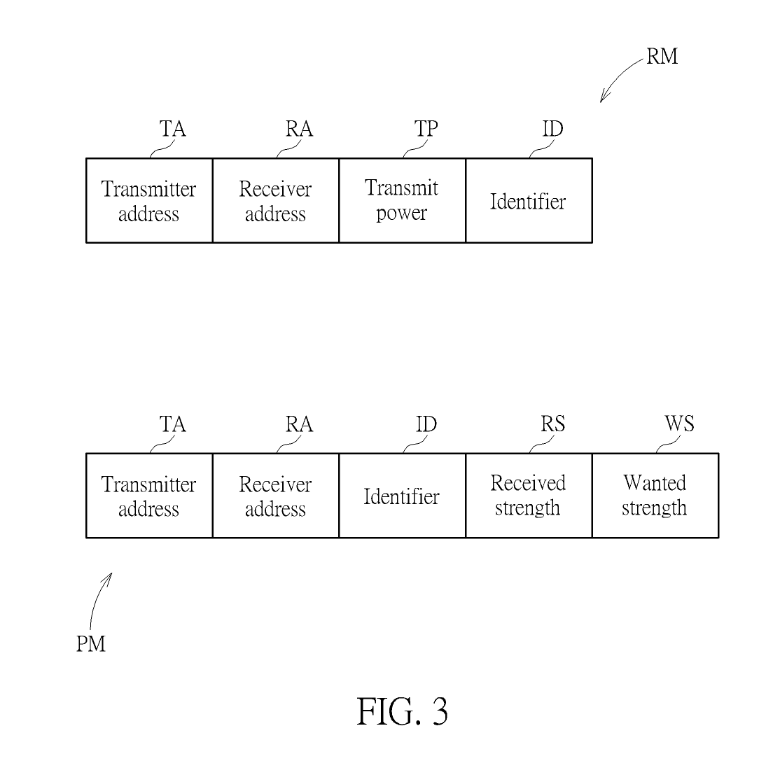

FIG. 3 is a schematic diagram illustrating data structures of the request message and the report message in the embodiment of FIG. 2. In one embodiment, the request message RM and the report message PM are packages, but can be other kinds of data units as well. As illustrated in FIG. 3, the request message RM comprises transmitter address data TA, receiver address data RA, transmit power data TP and identifier data ID. The transmitter address data TA means an address for a device transmitting the request message RM, such as the first electronic device D_1 in FIG. 2. Further, the receiver address data RA means an address for a device receiving the request message RM, such as the second electronic device D_2 in FIG. 2. Additionally, the transmit power data TP means the above-mentioned transmitting power information. Besides, the identifier data ID is applied for the identification of the request message RM.

In one embodiment, the transmitter address data TA, the receiver address data RA, the transmit power data TP and the identifier data ID respectively occupies one byte of the request message RM, but not limited.

Please refer to FIG. 3 again, the report message PM comprises transmitter address data TA, receiver address data RA, an identifier data ID, received strength data RS and wanted strength data WS. The transmitter address data TA means an address for a device transmitting the report message PM, such as the second electronic device D_2 in FIG. 2. Further, the receiver address data RA means an address for a device receives the report message PM, such as the first electronic device D_1 in FIG. 2. The meaning of the identifier data ID of the report message PM is the same as which of the request message RM, thus are omitted for brevity here. The received strength data RS indicates the above-mentioned received strength information and the wanted strength data WS indicates the above-mentioned wanted strength information.

In one embodiment, the report message PM is a package. Also, the transmitter address data TA, the receiver address data RA, the identifier data ID, the received strength data RS and the wanted strength data WS respectively occupies one byte of the report message PM, but not limited.

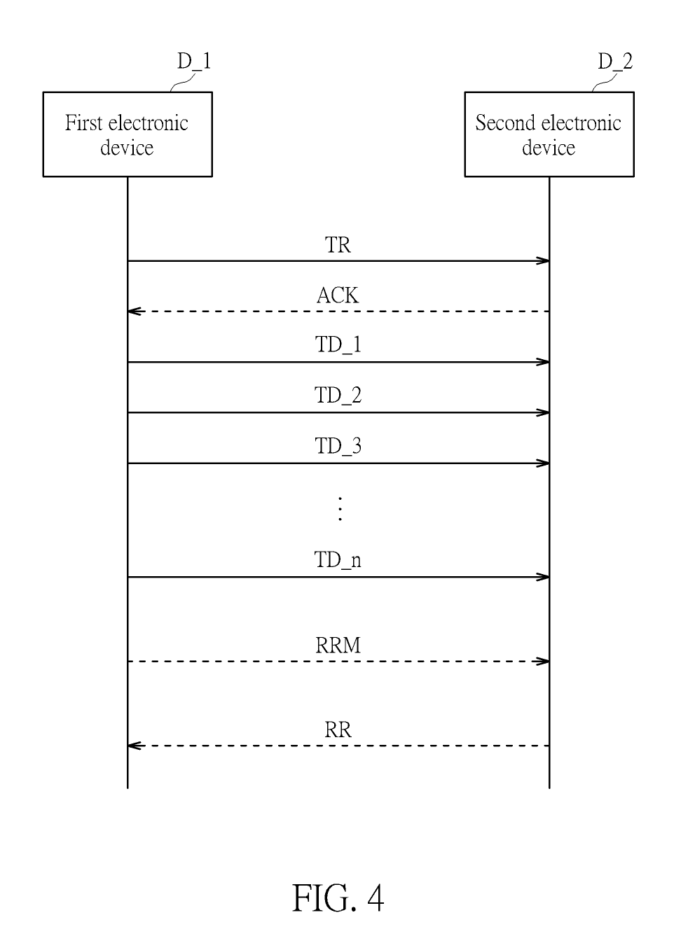

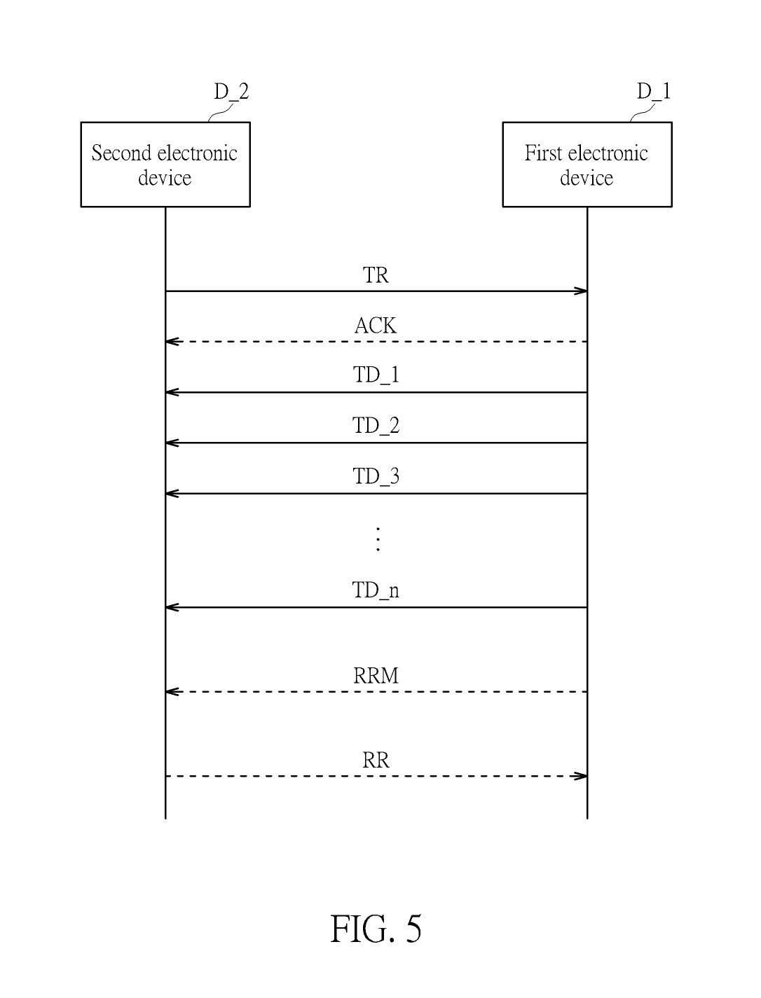

Besides the above-mentioned embodiment of FIG. 2, the present application further provides other embodiments of communication link checking methods. FIG. 4 and FIG. 5 are schematic diagrams illustrating communication link checking methods according to different embodiments of the present application. In such embodiments, a plurality of test data units are transmitted from one electronic device to another electronic device, and a quality of the communication link is determined according to transmitting states or receiving states of the test data units.

For more detail, in the embodiment of FIG. 4, the first electronic device D_1 firstly transmits a test request message TR to the second electronic device D_2. The test request message TR comprises direction information indicating a transmitting direction of the test data units TD_1 . . . TD_n. In other words, the direction information indicates whether the test data units TD_1 . . . TD_n are transmitted from the first electronic device D_1 to the second electronic deviceD_2 or transmitted from the second electronic device D_2 to the first electronic device D_1. In the embodiment of FIG. 4, the direction information indicates the test data units TD_1 . . . TD_n are transmitted from the first electronic device D_1 to the second electronic device D_2. The second electronic device D_2 may responds a confirm message ACK to the first electronic device D_1 after receives the test request message TR.

After that, the test data units TD_1 . . . TD_n are transmitted from the first electronic device D_1 to the second electronic device D_2. Next, the first electronic device D_1 sends a result request message RRM to the second electronic device D_2. Responding to the result request message RRM, the second electronic device D_2 sends at least one receiving result RR to the first electronic device D_1. Then, the quality of the communication link between the first electronic device D_1 and the second electronic device D_2 is determined according to the receiving result RR.

The above-mentioned quality determining step can be performed by either the first electronic device D_1 or the second electronic device D_2. Also, the quality determining step can be performed by an electronic device independent from the first electronic device D_1 and the second electronic device D_2. Moreover, in one embodiment, the second electronic device D_2 can initiatively transmit the receiving result RR to the second electronic device D_2, after receiving the test data units TD_1 . . . TD_n rather than responding to the result request message RRM.

In one embodiment, the test request message TR comprises information about a number of the test data units which will be transmitted (e.g. n test data units will be transmitted in the embodiment of FIG. 4). The above-mentioned n can be a positive integer larger or equal to 1. In another embodiment, the test data units TD_1 . . . TD_2 respectively comprises order information indicating an order of the test data units. For example, n test data units will be transmitted, thus the test data unit TD_1 comprises order information indicating it is the first test data unit, and the test data unit TD_2 comprises order information indicating it is the second test data unit.

Also, in one embodiment, the receiving result RR comprises at least one of: a number of the test data units which are received, an average signal strength of the test data units and a frame error rate. Therefore, the quality of the communication link between the first device D_1 and the second device D_2 can be determined according to the receiving result RR. For example, if a difference between a number of the test data units which are transmitted and a number of the test data units which are received is large, it means the transmitted data is easily lost in this communication link, thus the communication link between the first electronic device D_1 and the second electronic device D_2 is determined as poor. Oppositely, if a difference between a number of the test data units which are transmitted and a number of the test data units which are received is large, it means the transmitted data is not easily lost in this communication link, thus the communication link between the first electronic device D_1 and the second electronic device D_2 is determined as good.

For another example, if the average signal strength of the test data units TD_1-TD_n is low or the frame error rate is high, the communication link between the first electronic device D_1 and the second electronic device D_2 is determined as poor. On the opposite, if the average signal strength of the test data units TD_1-TD_n is high or the frame error rate is low, the communication link between the first electronic device D_1 and the second electronic device D_2 is determined as good.

In the embodiments of FIG. 4 and FIG. 5, for the convenience of understanding, the first electronic device D_1 means a device transmitting the test data units TD_1 . . . TD_n, and the second electronic device D_2 means a device receiving the test data units TD_1 . . . TD_n. In the embodiment of FIG. 4, the transmitting directions of the rest request TR and the test data units TD_1 . . . TD_n are the same. Also, in the embodiment of FIG. 5, the transmitting directions of the rest request message TR and the test data units TD_1 . . . TD_n are opposite.

Therefore, in the embodiment of FIG. 5, the second electronic device D_2 firstly transmits a test request message TR to the first electronic device D_1. The test request message TR also comprises direction information indicating a transmitting direction of the test data units TD_1 . . . TD_n. In the embodiment of FIG. 5, the direction information indicates the test data units TD_1 . . . TD_n are transmitted from the first electronic device D_1 to the second electronic device D_2. The first electronic device D_1 may responds a confirm message ACK to the second electronic deviceD_2 after receives the test request message TR.

After that, the test data units TD_1 . . . TD_n are transmitted from the first electronic device D_1 to the second electronic device D_2. Next, the first electronic device D_1 sends a result request message RRM to the first electronic device D_1. Responding to the result request message RRM, the second electronic device D_2 sends at least one receiving result RR to the first electronic device D_1. Then, the quality of the communication link between the first electronic device D_1 and the second electronic device D_2 is determined according to the receiving result RR.

The above-mentioned quality determining step can be performed by either the first electronic device D_1 or the second electronic device D_2. Also, the quality determining step can be performed by an electronic device independent from the first electronic device D_1 and the second electronic device D_2. Moreover, in one embodiment, the first electronic device D_1 can initiatively transmit the receiving result RR to the second electronic device D_2 rather than responding to the result request message RRM.

In one embodiment, the test request message TR comprises information about a number of the test data units which will be transmitted (e.g. n test data units will be transmitted in the embodiment of FIG. 5). In another embodiment, the test data units TD_1 . . . TD_2 respectively comprises order information indicating an order of the test data units. Also, in one embodiment, the receiving result RR comprises at least one of: a number of the test data units which are received, an average signal strength of the test data units and an frame error rate. Therefore, the quality of the communication link between the first device D_1 and the second device D_2 can be determined according to the receiving result RR. Each parameter contained in the test request message TR or the test data unit TD_1 . . . TD_2 has been explained in the embodiment of FIG. 4, thus descriptions thereof are omitted for brevity here.

In one embodiment, the first electronic device D_1 and the second electronic device D_2 in FIG. 5 are routers of a network. The network can be, for example, the above-mentioned mesh network which can be a Bluetooth network, but can be any other kind of network as well. Furthermore, the first electronic device D_1 and the second electronic device D_2 in FIG. 5 can be provided in the same area (e.g. city, province, or country), but can be provided in different areas as well.

Please note, the above-mentioned transmitting and receiving can mean directly or indirectly transmitting and receiving. Take FIG. 2 for example, the first electronic device D_1 transmits a request message RM to the second electronic device D_2 can mean the first electronic device D_1 generates and transmits a request message RM to the second electronic device D_2. However, it can also mean the first electronic device D_1 generates a request message RM to another third electronic device and then the third electronic device transmits the request message RM to the second electronic device D_2.

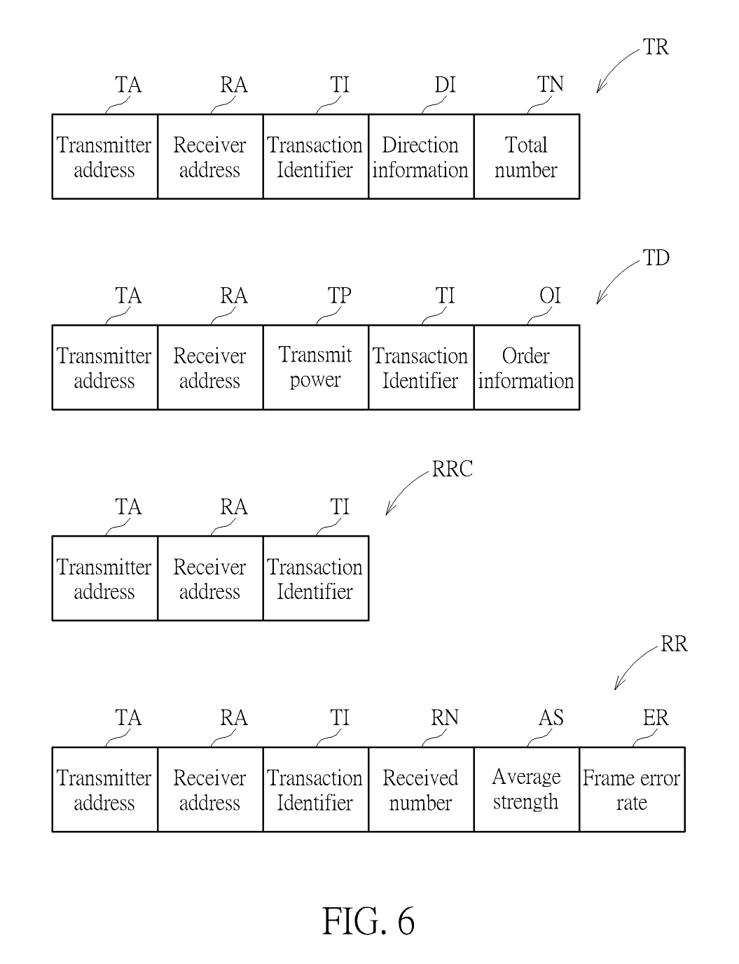

FIG. 6 is a schematic diagram illustrating examples for data structures of the request message TR, the test data unit TD, the result request message RRM, and the receiving result RR in the embodiments of FIG. 4 and FIG. 5. Please note, definitions of the transmitter address data TA and the receiver address data RA in FIG. 6 have been illustrated in above illustrations, thus descriptions thereof are omitted for brevity here. Further, the request message TR, the test data unit TD, the result request message RRM, the receiving result RR can be any kind of data unit, such as a PDU (Protocol Data Unit).

As illustrated in FIG. 6, the test request message TR comprises transmitter address data TA, receiver address data RA, transaction identifier data TI, direction information data DI, and total number data TN. The transaction identifier data TI is applied to identify the whole test steps. For example, the current test for checking a quality of the communication link is a first time test, and a second time test having the same steps may be performed later. The direction information data DI is the above-mentioned direction information indicating a transmitting direction of the test data units. Further, the total number data TN indicates a total number of the test data units which will be transmitted (e.g. n test data units in the embodiments of FIG. 4 and FIG. 5).

Besides, the test data unit TD (i.e. the above-mentioned test data unit TD_1 . . . TD_2) comprises transmitter address data TA, receiver address data RA, transmit power data TP, transaction identifier data TI, and direction information data DI. The definitions of transmitter address data TA, receiver address data RA, and transaction identifier data TI have been explained in above-mentioned descriptions. The transmit power data TP indicates the power that the first electronic device D_1 applies to transmit the test data units TD_1 . . . TD_n. The order information data OI comprise above-mentioned order information indicating an order of the test data units.

Additionally, the result request message RRM comprises transmitter address data TA, receiver address data RA, transaction identifier data TI, which have been defined in above-mentioned descriptions.

Furthermore, the receiving result RR comprises transmitter address data TA, receiver address data RA, transaction identifier data TI, which have been defined in above-mentioned descriptions. Besides, the receiving result RR further comprises received number data RN, average strength data AS, and frame error rate data ER. The received number data RN indicates a number of the test data units which are received, the average strength data AS indicates an average signal strength of the test data units, and frame error rate data ER indicates the frame error rate.

It will be appreciated that the data structures illustrated in FIG. 6 are only examples and do not mean to limit the scope of the present application. The data structures of the transmitter address data TA, the receiver address data RA, the transmit power data TP, transaction identifier data TI, and the direction information data DI can be changed to any required data structures.

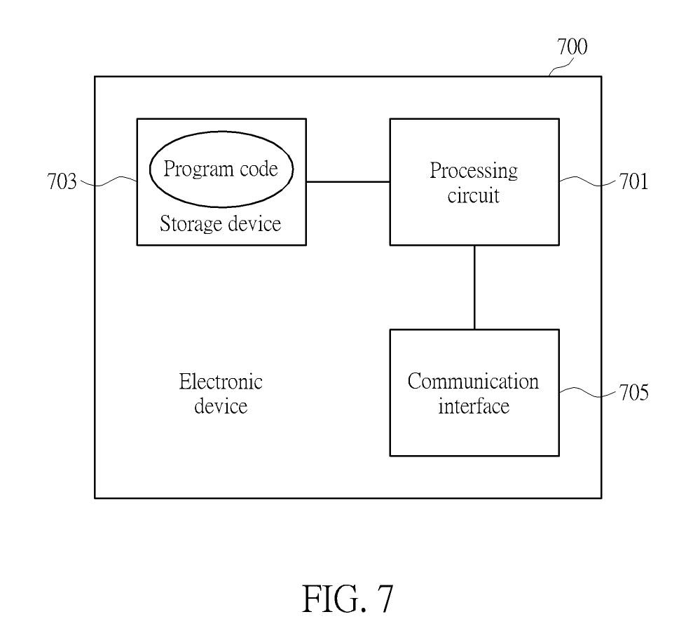

FIG. 7 is a block diagram illustrating the structures of the first electronic device D_1 or the second electronic device D_2 in FIG. 2, according to one embodiment of the present application. As illustrated in FIG. 7, the electronic device 700 comprises a processing circuit 701, a storage device 703 and a communication interface 705. The processing circuit 701 is configured to read the program code stored in the storage device 703 to execute the above-mentioned steps. Also, the communication interface 705 is configured to transmit data or to receive data. The storage device 703 can locate outside the electronic device 700 rather than locates inside the electronic device 700.

The electronic device 700 can be integrated to the first electronic device D_1 or to the second electronic device D_2. Additionally, the electronic device 700 can be an electronic device which is independent from but can control the first electronic device D_1 and the second electronic device D_2.

In view of above-mentioned embodiments, the quality of communication link can be checked, and proper communication links between routers can be selected according to the checking result. Accordingly, the conventional asymmetric link issue can be resolved. However, please note the present application is not limited to solve the asymmetric link issue.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication link checking method, applied to check a communication link of a first electronic device, comprising:
(a) receiving a report message, wherein the report message comprises received strength information indicating a received signal strength of a request message received by a second electronic device and comprises wanted strength information provided by the second electronic device; and
(b) determining a quality of the communication link according to the received strength information and the wanted strength information.

2. The communication link checking method of claim 1, further comprising:
generating the request message, wherein the request message comprises transmitting power information indicating a transmitting power which the first electronic device uses to transmit the request message;
wherein the step (b) further determines the quality according to the transmitting power information.

3. The communication link checking method of claim 1, wherein the first electronic device and the second electronic device are routers of a network, and the first electronic device and the second electronic device are Bluetooth devices.

4. The communication link checking method of claim 1, wherein the request message is a package and the transmitting power information occupies one byte of the package.

5. The communication link checking method of claim 1, wherein the report message is a package and transmitting power information, the received strength information and the wanted strength information respectively occupies one byte of the package.

6. A communication link checking method, applied to check a communication link of a second electronic device, comprising:
(a) generating and transmitting a report message to a first electronic device by the second electronic device, wherein the report message comprises received strength information indicating a received signal strength of a request message received by the second electronic device and comprises wanted strength information provided by the second electronic device provided by the second electronic device; and
(b) determining a quality of the communication link according to the received strength information and the wanted strength information.

7. The communication link checking method of claim 6, further comprising:
receiving the request message, wherein the request message comprises transmitting power information indicating a transmitting power which the first electronic device uses to transmit the request message;
wherein the step (b) further determines the quality according to the transmitting power information.

8. The communication link checking method of claim 6, wherein the first electronic device and the second electronic device are routers of a network.

9. The communication link checking method of claim 6, wherein the request message is a package and the transmitting power information occupies one byte of the package.

10. The communication link checking method of claim 6, wherein the report message is a package and transmitting power information, the received strength information and the wanted strength information respectively occupies one byte of the package.

11. A communication link checking method, applied to check a communication link of a first electronic device, comprising:
transmitting a plurality of test data units to a second electronic device by the first electronic device;
receiving a receiving result of the test data units; and
determining a quality of the communication link according to the receiving result.

12. The communication link checking method of claim 11, further comprising:
transmitting a test request message by the first electronic device before the test data units are transmitted from the first electronic device to the second electronic device;
wherein the test request message comprises direction information indicating a transmitting direction of the test data units.

13. The communication link checking method of claim 11, further comprising:
receiving a test request message by the first electronic device before the test data units are transmitted from the first electronic device to the second electronic device;
wherein the test request message comprises direction information indicating a transmitting direction of the test data units.

14. The communication link checking method of claim 11, wherein the test data unit comprises order information indicating an order of the test data units.

15. The communication link checking method of claim 11, wherein the receiving result comprises at least one of: a number of the test data units which are received, an average signal strength of the test data units and a frame error rate.

16. The communication link checking method of claim 11, wherein the first electronic device and the second electronic device are routers of a network, and the first electronic device and the second electronic device are Bluetooth devices.

17. A communication link checking method, applied to check a communication link of a second electronic device, comprising:
receiving a plurality of test data units from a first electronic device by the second electronic device;
generating a receiving result of the test data units; and
determining a quality of the communication link according to the receiving result.

18. The communication link checking method of claim 17, further comprising:
receiving a test request message by the second electronic device before the test data units are transmitted from the first electronic device to the second electronic device;
wherein the test request message comprises direction information indicating a transmitting direction of the test data units.

19. The communication link checking method of claim 17, further comprising:
transmitting a test request message by the second electronic device before the test data units are transmitted from the first electronic device to the second electronic device;
wherein the test request message comprises direction information indicating a transmitting direction of the test data units.

20. The communication link checking method of claim 17, wherein the test data unit comprises order information indicating an order of the test data units.

21. The communication link checking method of claim 17, wherein the receiving result comprises at least one of: a number of the test data units which are received, an average signal strength of the test data units and a frame error rate.

22. The communication link checking method of claim 17, wherein the first electronic device and the second electronic device are routers of a network, and the first electronic device and the second electronic device are Bluetooth devices.
